(19) United States
(12) Patent Application Publication
(10) Pub. No.: US 2010/0179967 A1
(43) Pub. Date: Jul. 15, 2010

(54) MAP-Queue-Based Data Transfer Method

(75) Inventors: CHUNFEI ZHANG, Nanjing (CN); HAIHUA SONG, Nanjing (CN); LIBIN SUN, Nanjing (CN); ZHIQIANG LU, Nanjing (CN); BENDONG WEI, Nanjing (CN); FUHAI GAO, Nanjing (CN)

Correspondence Address: GLOBAL IP SERVICES, 7285 W. Eagle Court, Winton, CA, 95388, US

(73) Assignee: LINKAGE TECHNOLOGY GROUP CO., LTD., Nanjing (CN)

(21) Appl. No.: 12/644,763

(22) Filed: Dec. 22, 2009

(30) Foreign Application Priority Data
Jan. 9, 2009 (CN) 200910028105.7

(51) Int. Cl. G06F 17/30

(52) U.S. Cl. 707/802; 707/E17.005

(57) ABSTRACT

As for the data transfer method based on MAP, adopts a MAP data structure during the data transferring process and configures it using SOID (Standard of Interface Department) syntax after encapsulation; the definition of MAP data structure; one system consists of many matching and individual source ends and target ends, one source end just accesses to its matching target end, and vice versa, all member methods of source and target end adopt MAP structure to transfer data, logic implementation steps are shown as below: data processing of database is the most basic and most featured part of BRS system which adopts SOID syntax, if a table is not simply imported into another Oracle database, it should be treated by another process, that is, generate a derived class directly, and then rewrite “Key process”; data transfer method based on MAP bring excellent compatibility. It nearly supports all kinds of existing platforms, protocols, businesses and manufacturers.

### CROSS REFERENCE TO RELATED PATENT APPLICATIONS

This application claims the priority of the Chinese patent application No. 200910028105.7 filed on Sep. 1, 2009, which application is incorporated herein by reference.

### FIELD OF THE INVENTION

This invented method belongs to the field of software protocol interface. It is, in particular, a kind of MAP-queue-based data transfer method for different protocols and platforms.

### BACKGROUND OF THE INVENTION

At present, interface parts of telecommunication operator's systems vary a lot in terms of number and category, so telecommunication software company often set up an interface team, and even some department is exclusively in charge of developing interfaces. At the same time, because of the huge interface difference, it wastes a lot of labor and cost for early development, subsequent maintenance and update.

In general, business of telecommunication operators is mainly operated in the following ways:
1) Front office: most users will go to operation office for transaction
2) Automatic voice: transaction will be done by phone or SMS
3) “10000” hotline system: transaction will be directly done by “10000” hotline customer service system.
4) Bank: such as charge filling, etc.

Once a service has been accepted via any channel above, it will generate an order which will be sent, in a uniform format, to various kinds of switches, intelligent network and other back-office platforms. In general, all kinds of corresponding interfaces will be developed for different platforms and protocols.

The main sorts of platforms and protocols are classified as below.

(i) Platforms could be classified by: HLR; Switch; intelligent network; IVR, etc.

(ii) Protocols could be classified by: Socket(TCP/UDP); X.25; Q3; serial communication; FTAM; CMIASE; LLC2; Web Services; Sybase; Oracle; Tuxeuo; IBM MQ, etc.

(iii) Specific service of platforms could be classified by: BEL S1240-72/74 switch; HUAWEI CC08, SMP protocol; ZTE HLR, SMP; Nortel HLR; LAN platform (different companies will provide different interface protocols); ADSL platform (same as above); Personal Hand-phone System (PHS); Inter-village Phone System; One Button Operation System, Cooperate-system platform; V-Net platform; BIMS platform; Ericsson; F150; NEC; Siemens; Lucent.

Moreover, there are many different platform manufacturers developing different platforms. Combined all these factors together, it is harder to transfer business orders which are accepted by CRM to suit with each platform's interface protocols. To deal with this problem, it is necessary to set up an interface team in the process of developing operation supporting systems for China Telecom, China Mobile and China Unicom, at early stage, the interface team just developed an application for a group of interfaces of the similar nature. But it still needs to develop a great deal of software protocols and versions, therefore, adding more demanding requirements to the interface team. In this case, this new technology is invented, which could shield the difference of platforms and deal with all operations on a unified basis. The primary technology of this method is MAP data structure which is a kind of application to achieve the function of shielding difference.

### SUMMARY OF THE INVENTION

The main theory of the present invention is that unity the data transferring of the different environments. After encapsulated MAP, it becomes a more strong structure of data transferring. With the help of SOID (Standard of Interface Department) syntax, application software system could unify data storage and transfer. The data will be treated unified among the software versions of different platform, different protocol and different manufacturers. It integrates a lot of interface systems into one application software, makes software maintenance and management easier.

A data transfer method based on MAP, a data system is divided into a source end and a target end, which transfers data from the source end to the target end and contains both synchronous and asynchronous mode, wherein

Adopts a MAP data structure during the data transferring process and configures it using SOID (Standard of Interface Department) syntax after encapsulation;

The definition of MAP data structure:

virtual functions defined in source end include connect function, reconnect function, select function, key treatment function, update function, error update function, finish function etc,

virtual functions defined in target end include connect function, reconnect function, insert function, select function, key treatment function, update function, error update function etc;

One system consists of many matching and individual source ends and target ends, one source end just accesses to its matching target end, and vice versa, all member methods of source and target end adopt MAP structure to transfer data, logic implementation steps are shown as below:

Operation layer: Adopt uniform logic to control synchronous and asynchronous mode, interface layer: Support data interactive operation from within and out of system;

Data layer: Data transfer based on MAP in the source end and the target end;

data processing of database is the most basic and most featured part of BRS system which adopts SOID syntax, if a table is not simply imported into another Oracle database, it should be treated by another process, that is, generate a derived class directly, and then rewrite “Key process”;

The application based on SOID syntax is shown as below:

Configure data transferring among databases at source end: in other words, the application of MAPKEY treatment, in the first, insert “OLCOM_WORK_ID” column of configuration table into MAPKEY named “id” column. Then, insert “SERIAL_NUMBER” and “SERVLIST” column into MAPKEY named “serial” and “servlist” column, each record generates a MAP object loading to the link list, source end uses “select” action to choose these data, then transfer every MAP objects of link list to matching target objects via “insert” action, “insert” action configuration is described as below;
insert into TI_ORDER_CD (ORDERID,MSISDN,SERVLIST)

values(‘̂Kid̂’,‘̂Kserial̂’,‘̂S1:2̂’)

below is the description of MAPKEY application;

̂Kid̂ means: read id value of MAPKEY.

̂Kserial̂ means: read serial value of MAPKEY.

̂S1:2̂ means: read the secondly group value of first services in servlist of MAPKEY.

As shown above, these are main configuration items of data transferring, if operations are related to many tables, it needs to add derived class to extend source and target end, when operation is just related to one table, and it could configure data transferring and parameter value translating functions directly. If CRM sends orders by MQ, it needs to add source derived class, and rewrite virtual functions which include connect, select, update, error update and finish, the matching actions in IBM MQ message queue are described as below:

Connect: connect to MQ message queue

Select: read MQ message

Update: delete MQ message

Error update: return MQ message

Finish: send encapsulation message to orders return queue

this derived class could give the name of generated MAPKEY directly, firstly, analyze the obtained message, then, define KEY and add it to MAPKEY directly, after configure target database derived class, it could process storage operation, without a need for second development;

If some intelligent network platform sends messages using web service, it needs to add target derived class, rewrite, connect and insert virtual function. In general, the request of web service is synchronism, actually, rewrite and connect virtual function is just the initialization step, rewrite insert action is the main step to implement all functions, in other words, the development of this system just needs rewrite one function, the project could obtain data from database and insert into MAP easily with the help of source end, it just needs to directly use MAPKEY according to its syntax to insert virtual function.

Advantages and characteristics:

1. Widely use. It used by all telecommunication operators systems in China which contains China Telecom, China Mobile and China Unicom companies.

2. Excellent compatibility. It nearly supports all kinds of existing platforms, protocols, businesses and manufacturers.

3. High expansibility. It not only support existing Chinese telecommunication system, but also has great expansibility to adapt future changes and difference systems of other country.

4. Economy. It reduces abundant cost of development, maintenance and management.

5. High capability. This standard brings high capability and easy operations to telecommunication systems.

### BRIEF DESCRIPTION OF THE DRAWINGS

The present invention will now be described by referring to the accompanying drawings that illustrate the preferred embodiments of the invention, from which its objects and features will be evident.

FIG. 1 shows a BRS system supported by SOID (Standard of Interface Department) syntax. Each platform and interface sent data to MAP object through uniform way firstly. Then, data is sent to according platform or interface. The transferring data is standard by MAP, and interface protocols are solved by derived class itself.

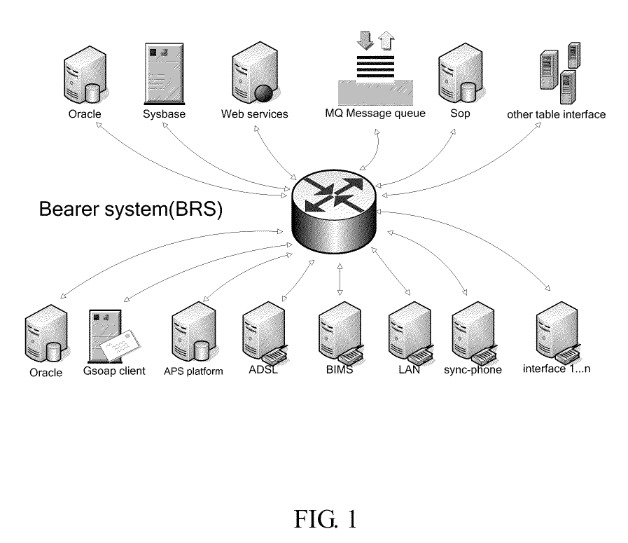

FIG. 2 shows the BRS system classes of main thread and configuration part. The drawing of BRS system classes is too large, so it is divided into two threads. FIG. 2 is main threads and configuration part. This kind of pair of thread could generate many pairs according to configuration objects. Every thread controls its own derived class object.

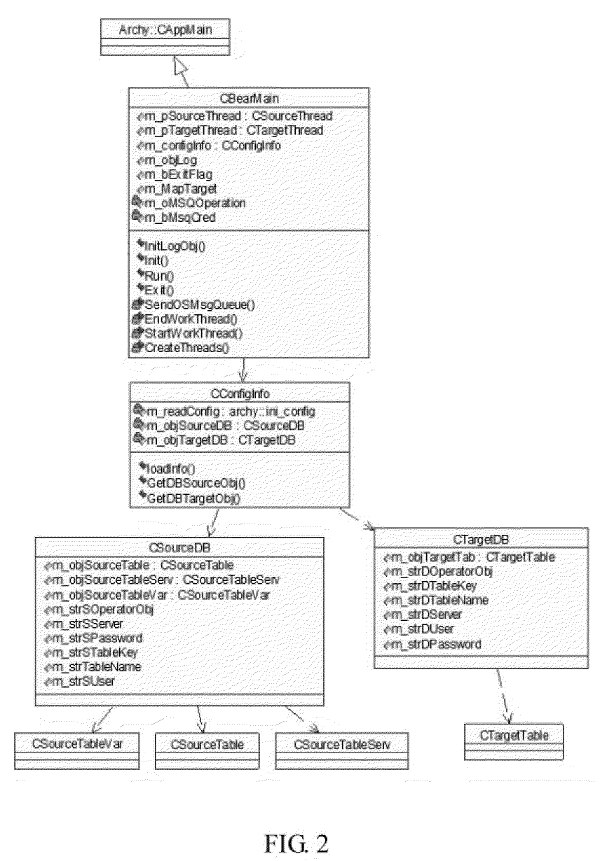

FIG. 3 shows the BRS system classes of source thread, target thread and derived class part.

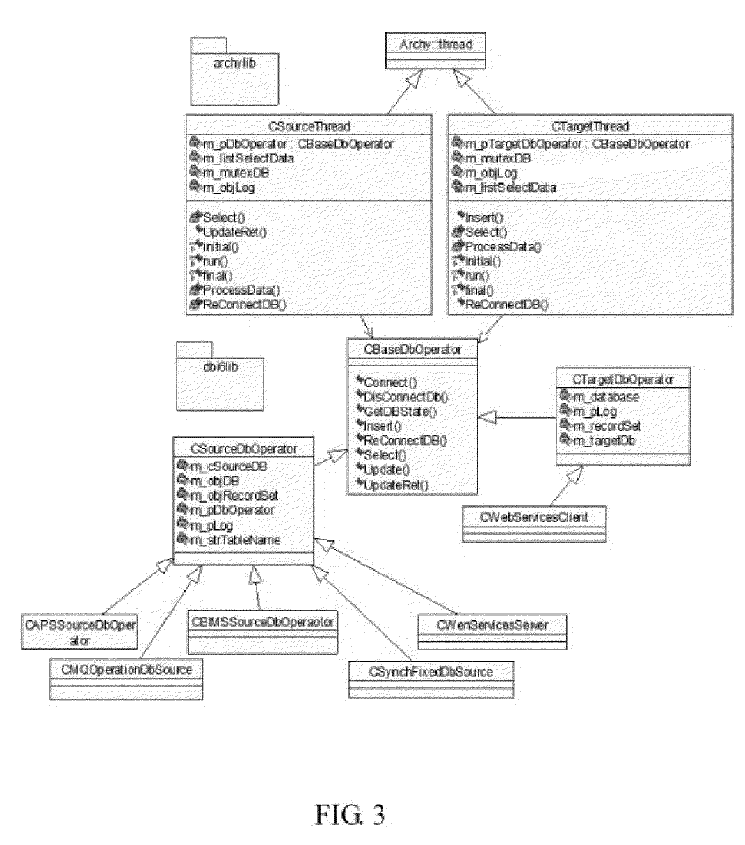

The foregoing descriptions of the embodiments and their accompanying drawings of the invention are intended to illustrate and not to limit this invention. Various changes and modifications may be made to the embodiments without departing from the spirit of the invention. Therefore, the scope of the invention is to be limited only by the appended claims.

### DETAILED DESCRIPTION OF THE INVENTION

1) Object

The main object of the present invention is that according to specific protocol and platform, constitute a standard of telecommunication interface department based on the data transfer method, to solve discrepancy of platform interfaces. For example, there are more than one hundred exterior interfaces in a telecom project. Once the telecom project adopts this invention, it just needs one process to solve all platform interface problem in theory. Hundreds of interface systems could make use of one software version. In addition, it has high expansibility and makes second development easier after over loading.

2) Technology Introduction

The data transfer method based on MAP is the primary technology of this standard, and contains both synchronous and asynchronous mode. Of course, MAP can not be used directly. To make the best capacity of MAP, it creates SOID (Standard of Interface Department) syntax, and appends MAP to the appropriate architecture.

The system has two parts, that is, source end (on upper part of picture 1) and target end (lower part of picture 1). The synchronous mode begins with transferring data from source end to target end, and ends by target end return. Once it is not finished, target end continues to choose these orders sending to source end actively. The whole process is named asynchronous mode. The key part of these processes is MAP data structure which is collocated by SOID (Standard of Interface Department) syntax after structure encapsulation.

(i). Logic Implementation

Operation Layer:

Adopt uniform logic to control synchronous and asynchronous mode.

Interface Layer:

Support data interactive operation from within and out of system.

Data Layer:

Data transfer based on MAP technology.

(ii). Technology Implementation

Virtual functions defined in source end include connect function, reconnect function, select function, key treatment function, update function, error update function, finish function etc.

Virtual functions defined in target end include connect function, reconnect function, insert function, select function, key treatment function, update function, error update function etc.

One system consists of many matching and individual source ends and target ends. One source end just accesses to its matching target end, and vice versa. All member methods of source and target end use MAP structure to transfer data.

In view of abundant various kinds of parameters existing in a heterogeneous system, this invention generates a new syntax to treat with MAP, called SOID (Standard of Interface Department) syntax. The principle of SOID syntax is to referring to a great deal of mapping objects, setting theirs key names and values, solving one value restricted to a matching variable.

(iii). Strongpoint

With the help of SOID syntax, heterogeneous protocols, heterogeneous systems and heterogeneous platforms got the uniform definition. It could send CRM orders to encapsulated protocol interfaces of all platforms in a uniform form. All platform manufacturers, platforms and protocols could cooperate easily among a uniform system, and get the uniform data from different sources.

3) Synchronous Mode and Asynchronous Mode

In the process of implementation, there are two modes, i.e., synchronous mode and asynchronous mode.

(i) Synchronous Mode

Synchronous mode includes three steps. Firstly, source end chooses data. Then, it inserts data into target end. Lastly, source end confirms successful message returned by target end.

(ii) Asynchronous Mode

Asynchronous mode includes five steps. The early three steps are as the same as those of synchronous mode, besides, it still has two additional steps. In the first, target end treats with the inserted data, and then returns the result via order returned to interface of source end. In the second, it will be finished by target end received confirmation.

Data processing of database is the most basic and most featured part of BRS system which adopts SOID syntax. If a table is not simply imported into another Oracle database, it should be treated by another process. That is, generate a derived class directly, and then rewrite “Key process”. The application based on SOID syntax is shown as below.

Configure data transferring among databases at source end: in other words, the application of MAPKEY treatment

SSelect=OLCOM_WORK_ID&id; SERIAL_NUMBER&serial;SERVLIST&servlist;

Description: In the first, insert “OLCOM_WORK_ID” column of configuration table into MAPKEY named “id” column. Then, insert “SERIAL_NUMBER” and “SERVLIST” column into MAPKEY named “serial” and “servlist” column. Each record generates a MAP object loading to the link list. Source end uses “select” action to choose these data, then transfer every MAP objects of link list to matching target objects via “insert” action. “Insert” action configuration is illuminated as below:
insert into TI_ORDER_CD(ORDERID,MSISDN,SERVLIST) values(‘̂Kid̂’,‘̂Kserial̂’,‘̂S1:2̂’)

Below is the description of MAPKEY application.

̂Kid̂means: read id value of MAPKEY.

̂Kserial̂ means: read serial value of MAPKEY.

̂S1:2̂ means: read the second group value of first services in servlist of MAPKEY. (The data format of servilst is 1+2+3, a+b+c, E+F+G)

As shown above, these are main configuration items of data transferring. If operations are related to many tables, it needs to add derived class to extend source and target end. When operation is just related to one table, it could configure data transferring and parameter value translating functions directly.

4) IBM MQ Message Queue Treatment

If CRM sends orders by MQ, it needs to add source derived class, and rewrite virtual functions which include connect, select, update, error update and finish. The matching actions in IBM MQ message queue are described as below.

Connect: connect to MQ message queue

Select: read MQ message

Update: delete MQ message

Error update: return MQ message

Finish: send encapsulation message to orders return queue

This derived class could give the name of generated MAPKEY directly. Firstly, analyze the obtained message. Then, define KEY and add it to MAPKEY directly. After configure derived class of target database, it could process storage operation, without a need for second development.

5) Web Service Message

Some intelligent network platforms transfer via web service messages. It needs to add target derived class, rewrite, connect and insert virtual function. In general, the request of web service is synchronism. Actually, rewrite and connect virtual function is just the initialization step. Rewrite insert action is the main step to implement all functions. In other words, the development of this system just needs to rewrite one function. The project could obtain data from database and insert into MAP easily with the help of source end. It just needs to directly use MAPKEY according to its syntax to insert virtual function. All above are the basic and main descriptions of MAPKEY and applications of MAP syntax. The format of some basic SOID syntax is shown as below.

̂KKey: 0̂ means: get value of KEY. (Default value is 0)

̂PU001:0̂ means: get value from parameter list. KEY of parameter list is defined as varlist. The format of its value is U001=1\0x01P002=2\0x01P003=3. (If U001 doesn't exist in varlist, default value is 0)

̂Sx:ŷ means: get value from parameter list. KEY of parameter list is defined as servlist. The format of its value is 1+2+3, a+b+c, E+F+G, which means to get number Y position of number X service.

̂RKey:x:ŷ means: replace the KEY name of KEY from MAPKEY. If the value is C, replace it with Y.

̂L1:=:2:,̂ means: filtrate or get service. This format is apart by “:”.If numbers between “:”, get corresponding value of service position in services list.

The SOID syntax could append a lot of functions which are as same difficult as regular expression, but have strong pertinence functions. The syntax could be extended simply, and used in any position. In addition, it could exist acting as an individual module.

What is claimed is:

1. A data transfer method based on MAP, the data system is divided into a source end and a target end, which transfers data from the source end to the target end and contains both synchronous and asynchronous mode, wherein
adopts a MAP data structure during a data transferring process and configures it using SOID (Standard of Interface Department) syntax after encapsulation;
a definition of the MAP data structure:
virtual functions defined in source end include connect function, reconnect function, select function, key treatment function, update function, error update function, finish function etc,
virtual functions defined in target end include connect function, reconnect function, insert function, select function, key treatment function, update function, error update function etc;
one system consists of many matching and individual source ends and target ends, one source end just accesses to its matching target end, and vice versa, all member methods of source and target end adopt MAP structure to transfer data, logic implementation steps are shown as below:
operation layer: Adopt uniform logic to control synchronous and asynchronous mode, interface layer: Support data interactive operation from within and out of system; data layer: based on data transfer of map, referring to the map object in the Source end and Target end, using the key name and key value of map to set up this characteristic.
data processing of database is the most basic and most featured part of BRS system which adopts SOID syntax, if a table is not simply imported into another Oracle database, it should be treated by another process, that is, generate a derived class directly, and then rewrite “Key process”;
the application based on SOID syntax is shown as below:
configure data transferring among databases at source end: in other words, the application of MAPKEY treatment, in the first, insert “OLCOM_WORK_ID” column of configuration table into MAPKEY named “id” column. Then, insert “SERIAL_NUMBER” and “SERVLIST” column into MAPKEY named “serial” and “servlist” column, each record generates a MAP object loading to the link list, source end uses “select” action to choose these data, then transfer every MAP objects of link list to matching target objects via “insert” action, “insert” action configuration is described as below;
insert into TI_ORDER_CD (ORDERID, MSISDN, SERVLIST) values (‘̂Kid̂’,‘̂Kserial̂’,‘̂S1:2̂’)
below is the description of MAPKEY application;
̂Kid̂means: read id value of MAPKEY,
̂Kserial̂means: read serial value of MAPKEY,
̂S1:2̂ means: read the secondly group value of first services in servlist of MAPKEY;
as shown above, these are main configuration items of data transferring, if operations are related to many tables, it needs to add derived class to extend source and target end, when operation is just related to one table, it could configure data transferring and parameter value translating functions directly.

2. A data transfer method based on MAP of claim 1, wherein If CRM sends orders by MQ, it needs to add source derived class, and rewrite virtual functions which include connect, select, update, error update and finish, the matching actions in IBM MQ message queue are described as below:
Connect: connect to MQ message queue
Select: read MQ message
Update: delete MQ message
Error update: return MQ message
Finish: send encapsulation message to orders return queue
this derived class could give the name of generated MAPKEY directly, firstly, analyze the obtained message, then, define KEY and add it to MAPKEY directly, after configure target database derived class, it could process storage operation, without a need for second development;
if some intelligent network platform sends messages using web service, it needs to add target derived class, rewrite, connect and insert virtual function. In general, the request of web service is synchronism, actually, rewrite and connect virtual function is just the initialization step, rewrite insert action is the main step to implement all functions, in other words, the development of this system just needs rewrite one function, the project could obtain data from database and insert into MAP easily with the help of source end, it just needs to directly use MAPKEY according to its syntax to insert virtual function.
